(19) United States
(12) Patent Application Publication
(10) Pub. No.: US 2013/0278519 A1
(43) Pub. Date: Oct. 24, 2013

(54) ELECTRONIC DEVICE WITH DRAWING FUNCTION AND DRAWING METHOD THEREOF

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: PENG WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/865,150

(22) Filed: Apr. 17, 2013

(30) Foreign Application Priority Data
Apr. 19, 2012 (CN) 201210116031.4

(51) Int. Cl. G06F 3/0488

(52) U.S. Cl. CPC G06F 3/0488
USPC 345/173

(57) ABSTRACT

In a drawing method of an electronic device, a touch device detects contact positions on the touch device corresponding to user operations, converts pressures applied to the points of contact into corresponding piezoelectric signals, and calculates coordinates of the contact positions. A plurality of colors are available and selectable by a user. The objects are drawn based on the coordinates of the contact positions from the touch device and the set color. The color shading of each point of the drawing depends upon the contact pressures as signified by the piezoelectric signals.

### BACKGROUND

1. Technical Field

The present disclosure relates to electronic devices, and particularly to an electronic device with drawing function and a drawing method for the electronic device.

2. Description of Related Art

Many people, such as calligraphers and painters, use traditional ink to practice handwriting and draw on paper; however, this causes waste and is not environmentally friendly.

Therefore, it is desirable to provide a means which can overcome the above-mentioned problems.

### BRIEF DESCRIPTION OF THE DRAWINGS

FIG. 1 is a schematic block diagram illustrating one embodiment of an electronic device including a drawing system.

FIG. 2 is a schematic diagram of an initial graphical user interface of the drawing system.

FIG. 3 is a flowchart of one embodiment of a drawing method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

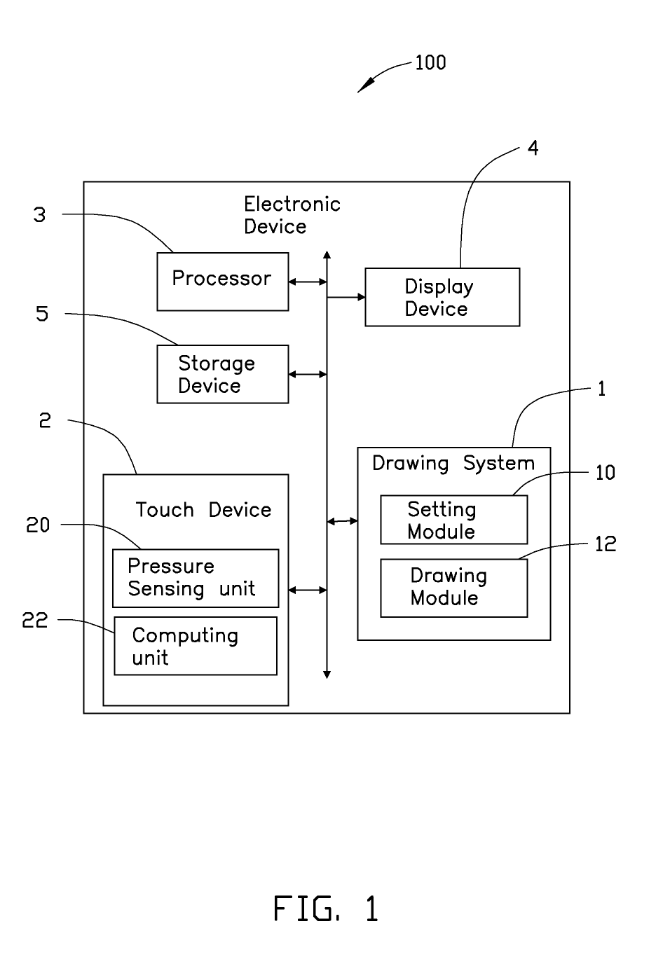

In FIG. 1, an electronic device 100 includes a touch device 1, a drawing system 2, a processor 3, a display device 4, and a storage device 5. In one embodiment, the electronic device 100 may be an input device with a large screen, for example. FIG. 1 is only one example of the electronic device 100, and the electronic device 100 may include more or fewer components than those shown in the embodiment, or have a different configuration of the components.

The touch device 1 is positioned near a display surface (not labeled) of the display device 4. The touch device 1 is used as an input interface for user operations. In the present embodiment, the touch device 1 may be a piezoelectric touch device, for example. The touch device 1 detects contact positions on the touch device 1 corresponding to the user operations, converts pressures applied to the contact positions into piezoelectric signals, calculates coordinates of the contact positions on the touch device 1, and outputs the piezoelectric signals and the coordinates of the contact positions to the drawing system 2. The piezoelectric signals may be voltages. Each piezoelectric signal corresponds to a contact position and indicates a value of a pressure applied to each contact position. The contact positions refer to one or more positions on the touch device 1 that are contacted by the user.

The touch device 1 includes a plurality of pressure sensing units 10 and a computing unit 12. The pressure sensing units 10 sense pressures applied to the contact positions on the touch device 1 from a finger of a user, a writing brush, or other input implements, and output corresponding piezoelectric signals based on the sensed pressures. The pressure sensing units 10 may be pressure sensors or pressure sensing circuits, for example. The computing unit 12 calculates the coordinates of the contact positions on the touch device 1. A number of software programs are stored in the computing unit 12 or in the storage device 5 or in another storage device (not shown) available to the computing unit 12, or appropriate hardware components are integrated into the computing unit 12, or firmware may be installed in the computing unit 12, such that the computing unit 12 calculates the coordinates of the contact positions on the touch device 1.

The drawing system 2 may include a plurality of programs in the form of one or more computerized instructions stored in the storage device 5 and executed by the processor 3 to perform operations of the electronic device 100. In the embodiment, the drawing system 2 includes a setting module 20 and a drawing module 22. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The setting module 20 displays an interface that provides a plurality of selectable colors for the user and sets a color for objects (e.g., text, figures, or images) that are drawn according to a selection of the user. The setting module 20 further displays an interface that provides other functions for the user in drawing the objects, such as a copy function and an erase function. The drawing module 22 draws the objects according to the coordinates of the contact positions output from the touch device 1 and the color set by the setting module 20. The drawn objects are generated and displayed with the set color on the display device 4 according to each of the contact positions. Each point of the drawn objects corresponds to one of the contact positions. The drawing module 22 further adjusts a shade of each color of each point of the drawn objects according to the piezoelectric signals. The shade of each point of the drawn objects is dependent upon the amount of pressure applied to the contact position corresponding to each point of the drawn objects. In the present embodiment, the shade of each point of the drawn objects becomes darker with an increase of the pressure, thus light contact pressure results in lighter shades.

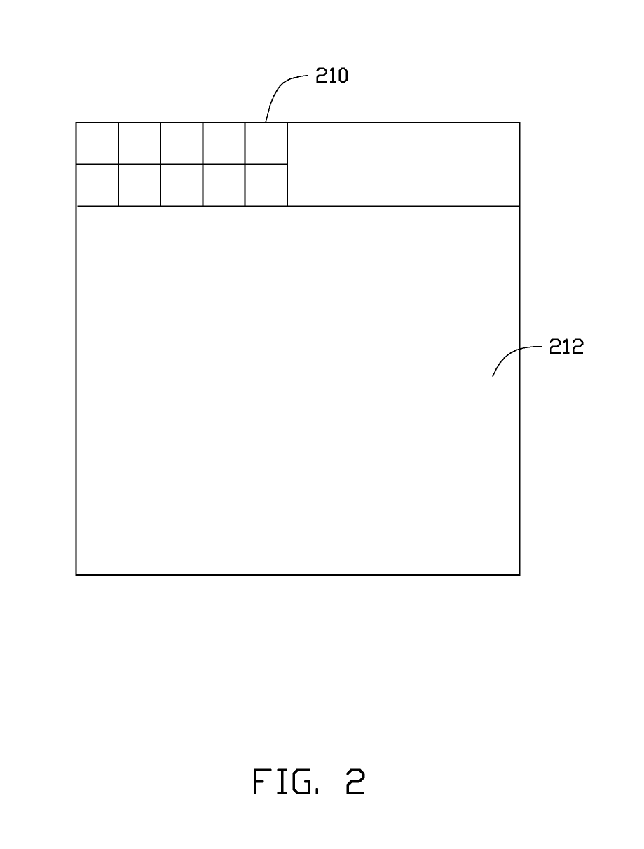

In FIG. 2, when the drawing system 2 is activated, an initial graphical user interface (GUI) 210 configured for drawing the objects is displayed on the display device 4. In one example, the colors provided by the setting module 20 are displayed at the upper left corner of the GUI 210. A blank area 212 under the displayed colors can be defined to be a drawing area for drawing the objects. When contact(s) is made on the blank area 212, the drawing module 22 draws objects according to the coordinates of the contact positions output from the touch device 1, and displays the objects with the set color on the display device 4. The shade of color of each point of the drawing is determined according to the piezoelectric signals corresponding to each contact position.

Since the electronic device 100 with drawing function includes the drawing system 2, the electronic device 100 can draw objects according to the coordinates of the contact positions utilized by the user on the touch device 1. The color of the drawn objects can be determined by the user according to requirements using the setting module 20, and the shading of each color of each point of the drawing can be adjusted according to the pressure applied to each contact position. As mentioned above, the electronic device 100 is capable of simulating a traditional drawing method. Accordingly, neither ink nor paper is expended, which is much more favorable to the environment.

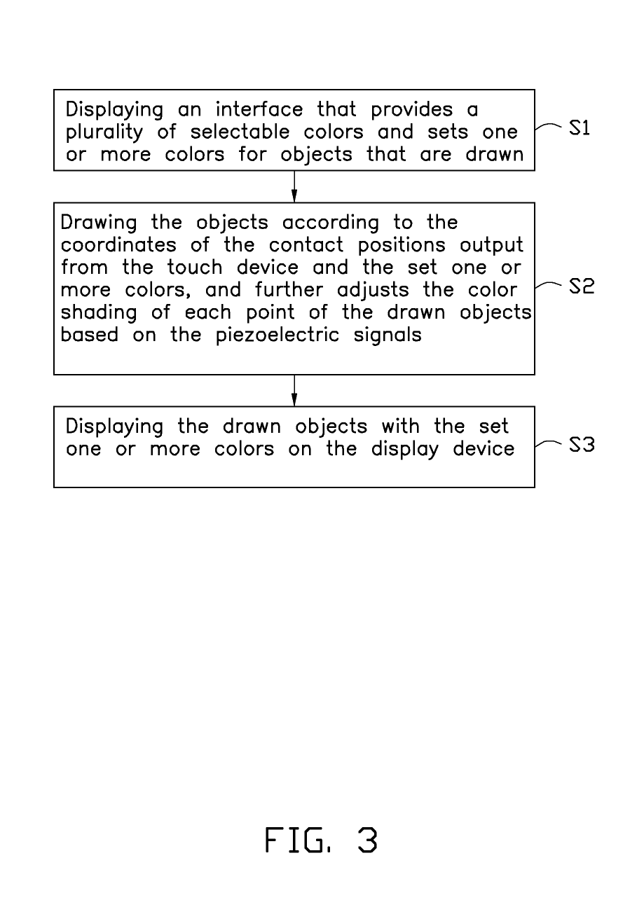

FIG. 3 is a flowchart of one embodiment of a drawing method of the electronic device 100 of FIG. 1. Depending on the embodiment, additional blocks may be added, others removed, and the ordering of the blocks may be changed.

In step S1, the setting module 20 displays an interface that provides a plurality of selectable colors for the user and sets one or more colors for objects (e.g., text, figures, or images).

In step S2, the drawing module 22 draws the objects according to the coordinates of the contact positions output from the touch device 1 and the one or more colors set by the setting module 20, and further adjusts the color shading of each point of the drawn objects according to the piezoelectric signals. Each point of the drawn objects corresponds to one of the contact positions. The color shading of each point of the drawing is changed according to the pressure applied to the individual contact positions. In the embodiment, the shade of color of each point of the drawn objects becomes darker with an increase of the pressure, and is lighter where light pressure is applied.

In step S3, the drawing module 22 displays the drawn objects with the set one or more colors on the display device 4 according to each of the contact positions.

In alternative embodiments, a plurality of points, or an outline, of a drawn object may correspond to only one of the contact positions.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A drawing method of an electronic device, the electronic device comprising a display device and a touch device that detects contact positions on the touch device corresponding to user operations, converts pressures applied to the contact positions into piezoelectric signals, and calculates coordinates of the contact positions, the method comprising:
displaying an interface that provides a plurality of selectable colors and sets one or more colors for objects that are drawn;
drawing the objects based on the coordinates of the contact positions from the touch device and the set one or more colors; and
adjusting shade of each color of each point of the drawn objects based on the piezoelectric signals.

2. The method according to claim 1, wherein the shade of color of each point of the drawn objects becomes darker with an increase of the pressure, the shade of color of each point of the drawn objects is lighter when light pressure is applied.

3. The method according to claim 2, further comprising:
displaying the drawn objects with the set one or more colors on the display device.

4. An electronic device, comprising:
a touch device detecting contact positions on the touch device corresponding to user operations, converting pressures applied to the contact positions into piezoelectric signals, and calculating coordinates of the contact positions;
a storage device;
at least one processor; and
one or more programs stored in the storage device and executed by the at least one processor, the one or more programs comprising:
a setting module displaying an interface that provides a plurality of selectable colors and sets one or more colors for objects that are drawn; and
a drawing module drawing the objects based on the coordinates of the contact positions from the touch device and the set one or more colors, and adjusting shade of each color of each point of the drawn objects based on the piezoelectric signals.

5. The electronic device according to claim 4, wherein the shade of color of each point of the drawn objects becomes darker with an increase of the pressure, the shade of color of each point of the drawn objects is lighter when light pressure is applied.

6. The electronic device according to claim 5, further comprising a display device, wherein the drawing module displays the drawn objects with the set one or more colors on the display device.

7. The electronic device according to claim 5, wherein the touch device comprises a plurality of pressure sensing units, and the pressure sensing units detects contact positions on the touch device corresponding to the user operations and converts the pressures applied to the contact positions into the piezoelectric signals.

8. The electronic device according to claim 7, wherein the touch device further comprises a computing unit, the computing unit calculates the coordinates of the contact positions based on the piezoelectric signals.

9. The electronic device according to claim 7, wherein the pressure sensing units comprises a plurality of pressure sensors.

10. The electronic device according to claim 7, wherein the pressure sensing units comprises a plurality of pressure sensing circuits.

11. A non-transitory storage medium having stored thereon instructions that, when executed by at least one processor of an electronic device comprising a display device and a touch device that detects contact positions on the touch device corresponding to user operations, converts pressures applied to the contact positions into piezoelectric signals, and calculates coordinates of the contact positions based on the piezoelectric signals, causes the electronic device to perform a method of drawing objects, the method comprising:
displaying an interface that provides a plurality of selectable colors and sets one or more colors for objects that are drawn;
drawing the objects based on the coordinates of the contact positions from the touch device and the set one or more colors; and
adjusting shade of each color of each point of the drawn objects based on the piezoelectric signals.

12. The storage medium according to claim 11, wherein the shade of color of each point of the drawn objects becomes darker with an increase of the pressure, the shade of color of each point of the drawn objects is lighter when light pressure is applied.

13. The storage medium according to claim 12, wherein the method further comprises:
displaying the drawn objects with the set one or more colors on the display device.
